(19) United States
(12) Patent Application Publication
(10) Pub. No.: US 2005/0036702 A1
(43) Pub. Date: Feb. 17, 2005

(54) System and method to enhance depth of field of digital image from consecutive image taken at different focus

(76) Inventors: Xiaoli Yang, Bellevue, WA (US); Shenzhi Zhang, Bellevue, WA (US)

Correspondence Address: Xiaoli Yang, 4225 143rd Ave. NE, Bellevue, WA, 98007, US

(21) Appl. No.: 10/914,759

(22) Filed: Aug. 9, 2004

Related U.S. Application Data
(60) Provisional application No. 60/494,424, filed on Aug. 12, 2003.

(51) Int. Cl. G06K 9/00; G06K 9/40

(52) U.S. Cl. 382/254; 382/284; 382/294

(57) ABSTRACT

An invention for generating an enhanced DEPTH OF FIELD image from a set of images taken with the same point of view but different focus planes is disclosed. The enhanced DEPTH OF FIELD is generated irrespective of the order of images takes or number of images taken as long as the number of images is more than two. The input images will be processed, possibly center aligned, scaled to match one another exactly, then a sharpness image map is generated to represent the largest sharpness value of each pixel position and image index to indicate from which image, then a smooth process is performed to remove any artifacts possibly caused by bringing pixels from different images. Finally an enhanced DEPTH OF FIELD image is generated.

### FIELD OF THE INVENTION

This invention is related to digital photography and digital imaging processing, more particularly, to process a series of digital images of the same objects or sceneries taken at different focus points and generate a final image that is with enhanced DEPTH OF FIELD.

### BACKGROUND OF THE INVENTION

In photography, it is often desirable to have every object in the picture in sharp focus, in other word, enhanced DEPTH OF FIELD. Photographers use available photography features, or some expensive photography lens to make the best possible DEPTH OF FIELD. To achieve the enhanced DEPTH OF FIELD requires the skills from the camera user or photographer. These skills are typically complex and require an expertise beyond that of ordinary users of photography devices and their photography equipments. There is a need for a digital imaging processing system in which the enhanced DEPTH OF FIELD will be achieved from a set of digital images without the limitation of the photography devices and user skills.

Traditionally, DEPTH OF FIELD is achieved in two ways through the use of camera equipments and skills. Photographer can stop down the lens to increase the DEPTH OF FIELD, stop down the lens mean to set to its smallest aperture and manually set focus at hyper focus, this way, it will achieve the most DEPTH OF FIELD. Or photographer can use a lens that can tilt so that he/she can change the focus plane by tilting the lens in a way to bring the objects of interests into focus.

Both of the solutions have shortcomings. To stop down the lens, user will encounter three problems. One is the limit of how much you can stop down the lens. In other words, there is a minimum aperture user can select. The second problem is that when the lens is stop down below its optimal aperture, the image quality will suffer due to diffraction. The third problem is that many cameras don't even have manual mode to allow photographer to change the aperture.

Enhance DEPTH OF FIELD by tilting lens has other set of problems. The camera system can be bulky, the lens can be very expensive, and the operation to tilt and focus is time consuming and needs expertise from photographers.

With technical advance of digital camera, more and more photos are taken by digital camera and one advantage of photos in digital form is that it is easy to process them digitally to improve the quality of the images. with the digital images as a part of our normal photo formats, there is a need to make the best DEPTH OF FIELD through digital image processing instead of limited DEPTH OF FIELD by the manipulation of camera equipments.

### SUMMARY OF THE INVENTION

According to the invention, a set of digital images taken at the same point of view but of different focus are used to obtain an image that has the enhanced DEPTH OF FIELD.

More specifically, first user takes a set of photos from same point of view, each photo are taken with different focus plane, for example, first photo focus on the front most object in the view, then focus on the medium object in the view, then focus on the far most object. Use of the tripod will keep the same point of view without hand shifting, just adjust the focus plane each time a photo is taken.

Then download the set of digital images from digital camera to computer system through USB or serial cable or directly import the images from compact flash slots on computers or any other process to get the images into computer.

This invention's system and method will first process the images to make sure all the images' centers are all aligned with the same object point in the view. In order to align the center, translation and rotation of images are sometimes necessary, center area matching will determine the amount to translate and rotate.

Then all the images will be processed to obtain a scale ratio. The scale ratio is used to scale the images, so that each image is in the perfect size of the other, so that all the objects in the image are match one another exactly.

After the scale ratio is determined, stretch each image according to the ratio to make them match each other in scale perfectly.

Then for each image element (“pixel”) position, evaluate the sharpness of the focus of all the images and record the index number of the image that has the sharpest focus for that position. Sharpness of a pixel position is determined by the amount the pixel differs from its surrounding pixels. We can then generate an image map that is a 2-D matrix with each of its elements mapping to a pixel in the image. The element has two values, one is an index number for each pixel position. The index is the index to the image that has the sharpest focus for the pixel position. The other is a sharpness value for the image that holds the best sharpness value for the position.

Then based on the image map, all the pixels are process to smooth out any artifacts caused by bringing in pixels from different images, the indexes in image map are adjusted to make the final image smoother.

Finally, the enhanced image is generated from assigning each pixel by the pixel value for that pixel position, which is weighted average of the pixel values for that position from each image weighted by the count of the indexes for each image contained in a small neighborhood of the position.

Additional features and advantages of the invention will be made apparent from the following detailed description of an illustrated embodiment which proceeds with reference to the accompanying drawings.

### BRIEF DESCRIPTION OF THE DRAWINGS

The appended claims set forth the features of the present invention with its advantages, may be best understood from the following detailed description taken in conjunction with the accompanying drawings of which:

FIG. 1 is a block diagram of an exemplary computer system 100 and 110 for processing digital images including a computer system for inputting digital images 105 using possible devices as digital cameras in accordance with the invention;

FIG. 2 is a high-level flow diagram describing the steps for generating an enhanced Depth of Field image;

FIG. 3 is a high-level flow diagram for center alignment for all the input digital images;

FIG. 4 is a detailed flow diagram specifying the steps for determining the translate for center alignment;

FIG. 5 is a detailed flow diagram specifying the steps for determining the rotation for center alignment;

FIG. 6 is a detailed flow diagram specifying the steps for finding scale ratio to stretch each image. So that all the images matches each other perfectly;

FIG. 7 is a detailed flow diagram specifying the steps for finding the sharpest points at each pixel position from all the images;

FIG. 8 is a detailed flow diagram specifying the steps for smoothing any artifacts from bringing pixels from different images.

FIG. 9 is a detailed flow diagram specifying the steps for generating the final enhanced DEPTH OF FIELD image;

FIG. 10A is a schematic diagram illustrating how to do the area match to determine the scale ratio;

FIG. 10B is a schematic diagram illustrating how to do the sharpness calculation for each pixel;

FIG. 11A is a schematic diagram illustrating how to do translation adjustment for center matching, illustrating the center area bounding box for match, and directions for translation;

FIG. 11B is an example image matrix area to illustrate how to use mean-square to determine the best match;

FIG. 12A is a schematic diagram illustrating how to do rotation adjustment for center matching, illustrating angles for rotation from center;

FIG. 12B is an example image matrix area of 3×3, it illustrates how to do weighted average on a matrix of 3×3.

### DETAILED DESCRIPTION OF THE INVENTION

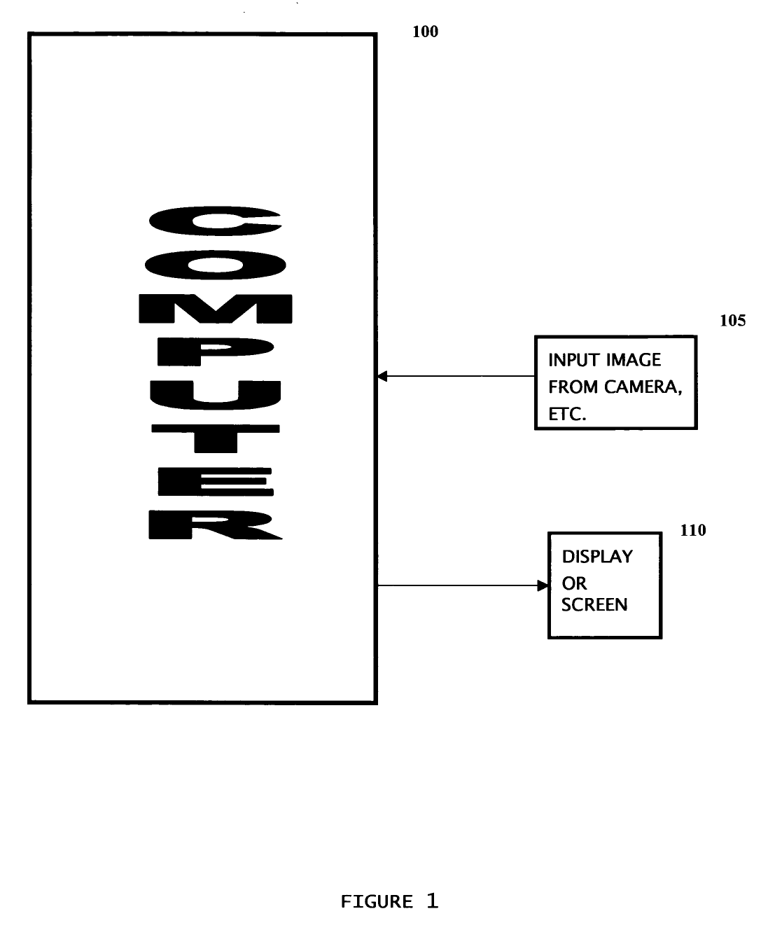

FIG. 1 and following discussion are intended to provide a brief, general description of a suitable computing environment in which the invention may be implemented. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skills in the art will appreciate that the invention may be practiced with other computer system configurations, including hand-held devices, multiprocessor system, microprocessor-based or programmable consumer electronics, e.g. digital cameras, network PCs, minicomputers, mainframe computers, and the like. The invention may also be practiced in distributed computing environment where tasks are performed by remote processing devices that are linked through a communications network. In a distributed computing environment, program modules may be located in both local and remote memory storage devices.

With reference to FIG. 1, an exemplary system for implementing the invention includes a general purpose computing device in the form of a conventional personal COMPUTER 100. The INPUT IMAGE part 105 illustrating input devices such as digital camera, which are often connected to the COMPUTER through a universal serial bus (USB), serial port, or parallel port. A DISPLAY 110 is a type of display device, such as monitor screen is also connected to the COMPUTER system through an interface such as video adapter.

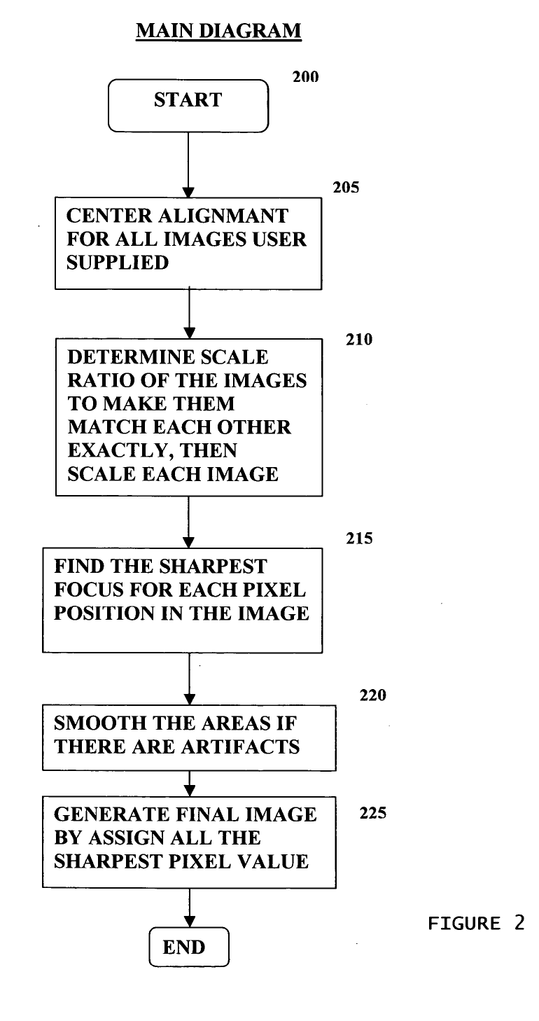

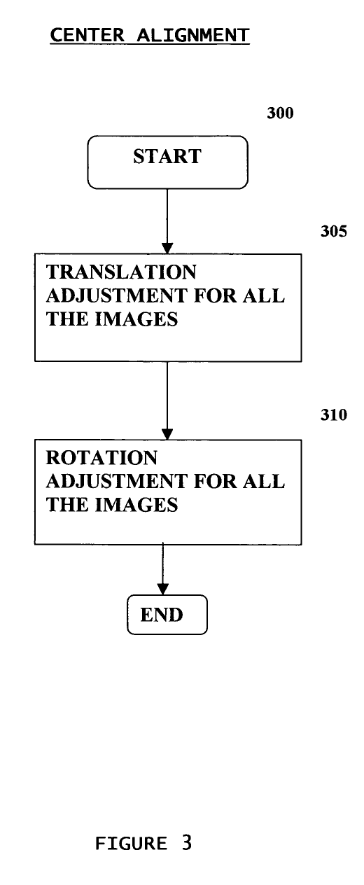

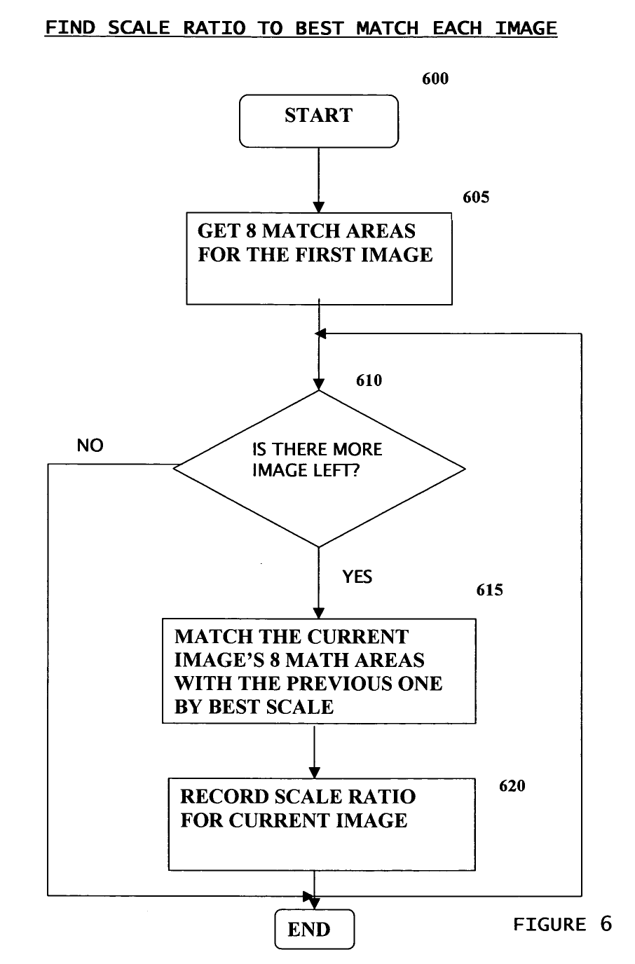

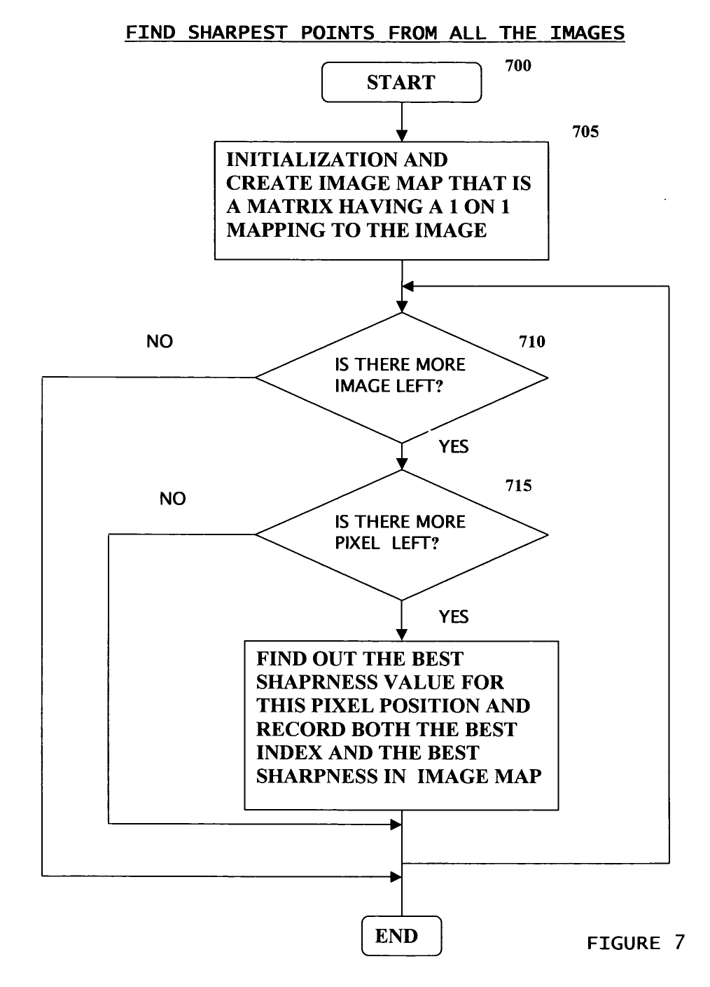

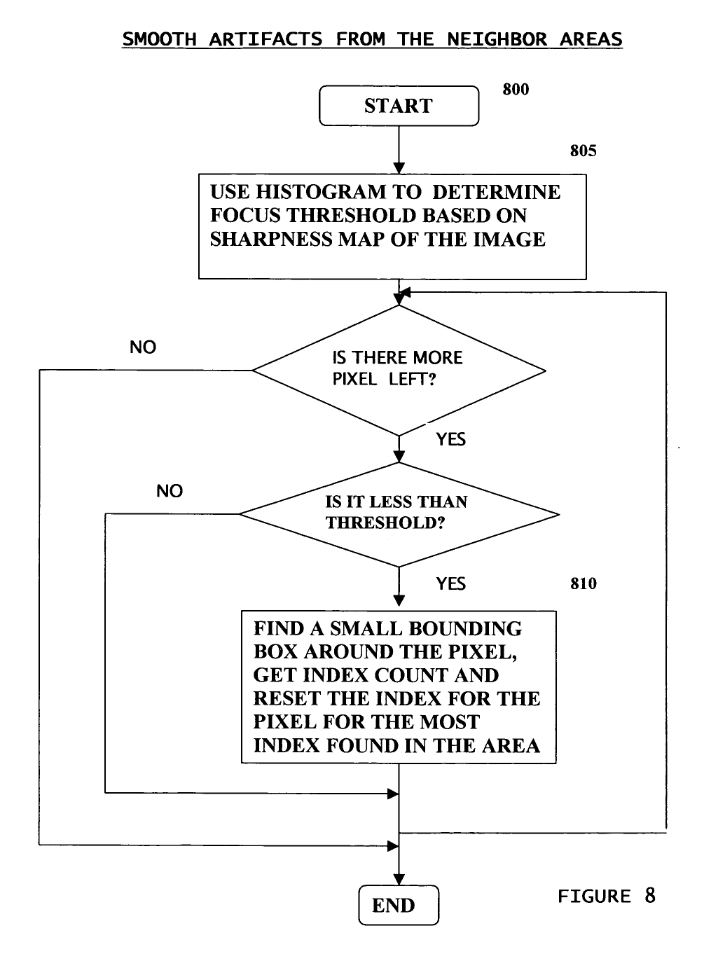

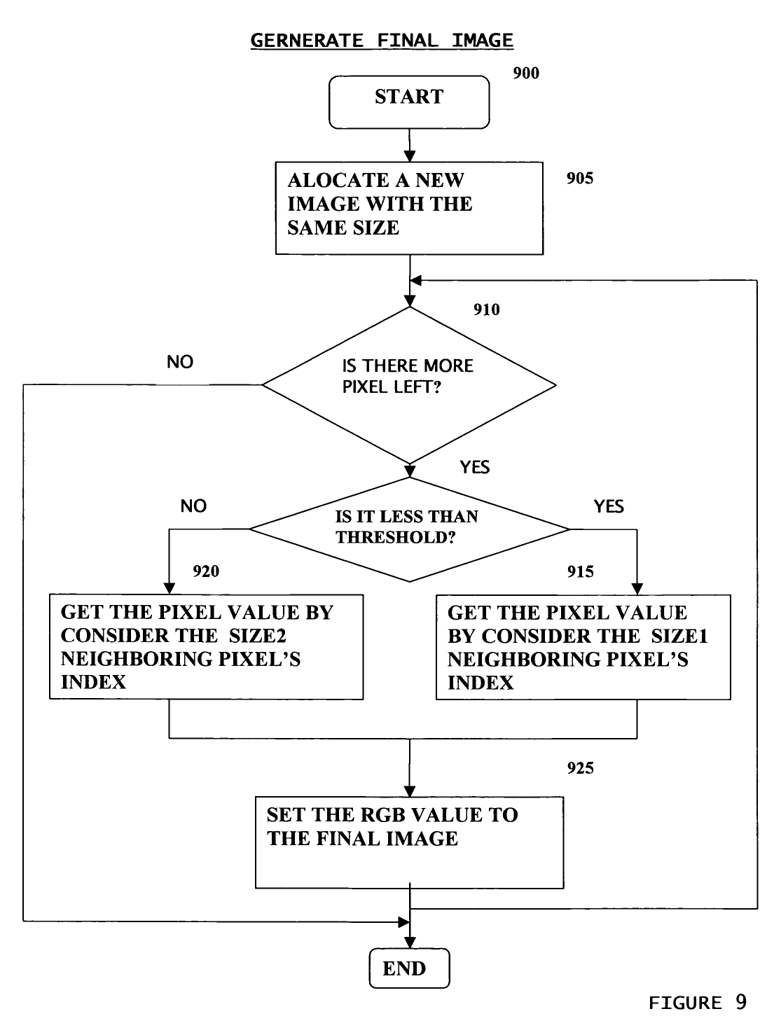

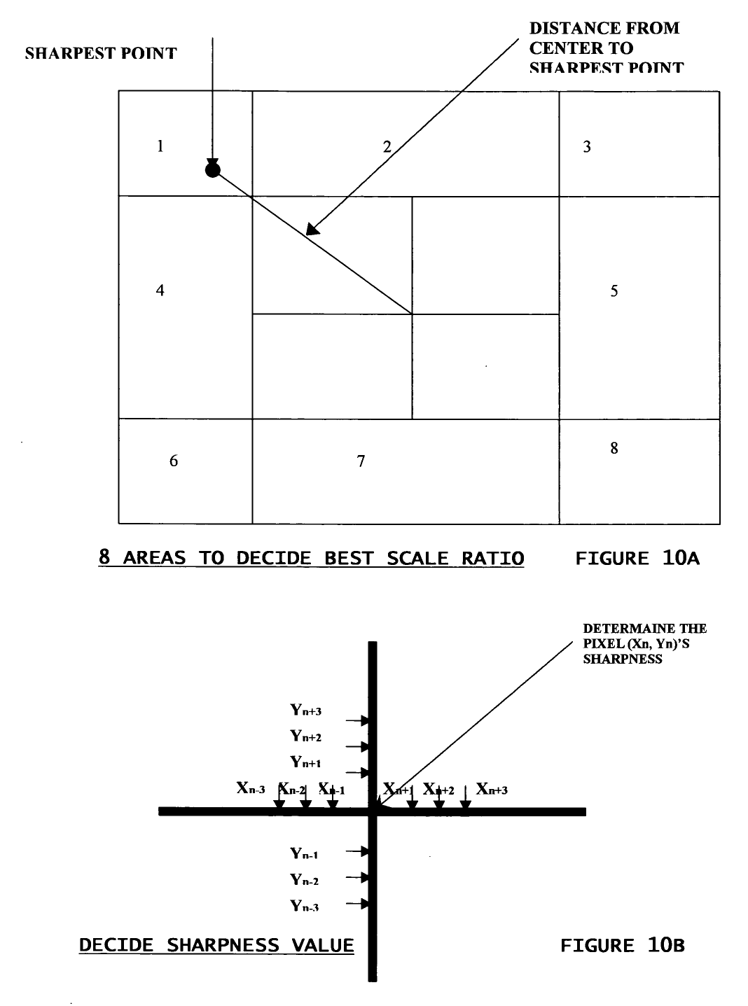

Turning now to FIG. 2, shown is a high-level flow diagram illustrating the steps performed to generate an enhanced DEPTH OF FIELD digital image in an embodiment in accordance with the invention. The high-level steps contained within this flow diagram will be described with reference to other figures: FIGS. 3, 4 and 5 provide a detailed flow diagram of step 205, FIG. 6 and schematic FIG. 10A provides a detailed flow diagram for step 210, FIG. 7 and schematic FIG. 10B provides a detailed flow diagram for step 215, FIG. 8 provides a detailed diagram for step 220, FIG. 9 provides a detailed diagram for step 225.

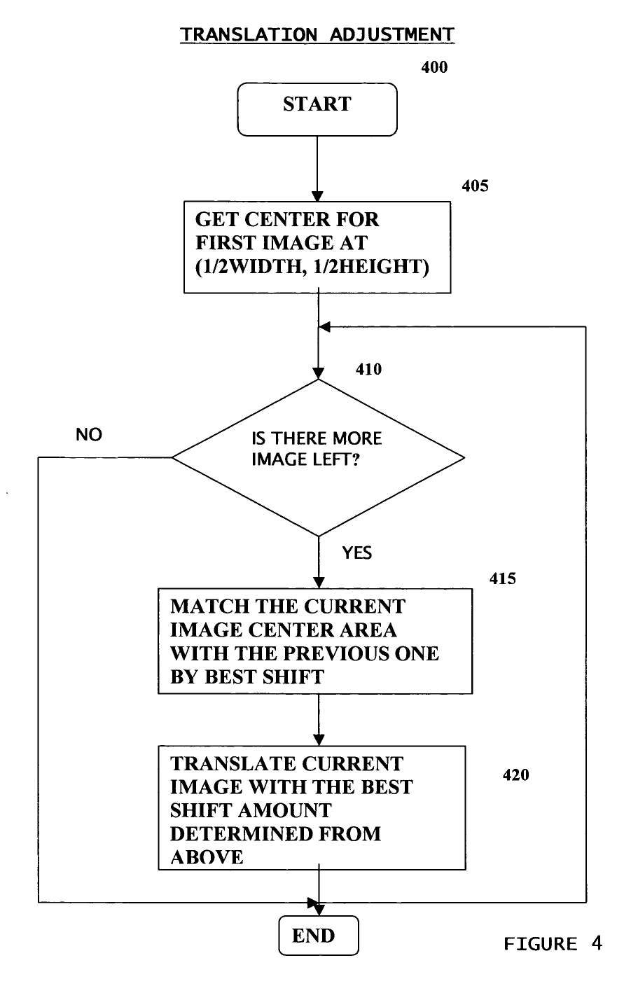

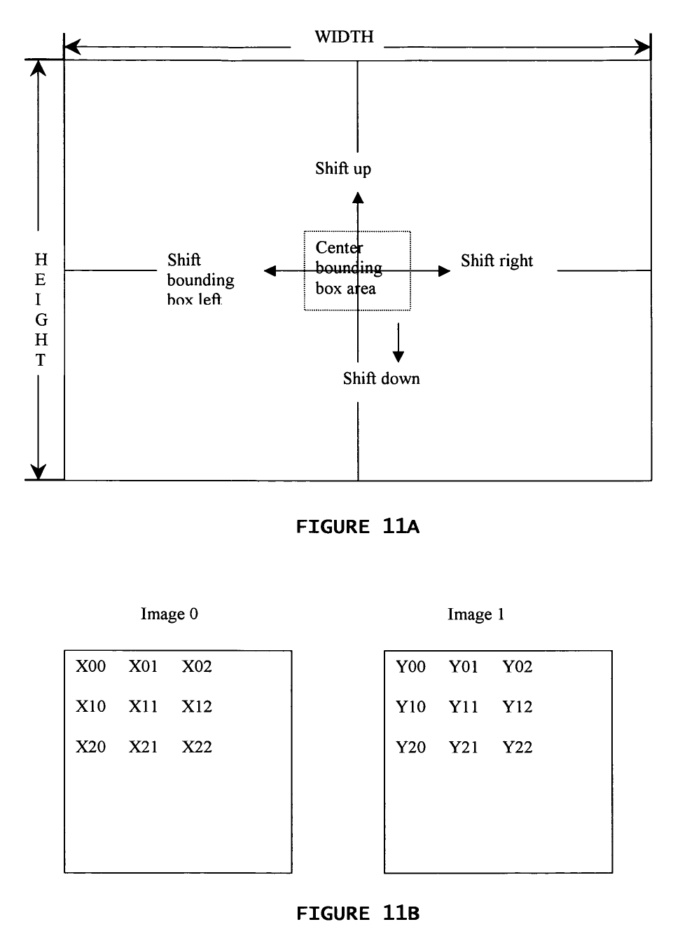

In the first step 205 of the embodiment disclosed in FIG. 2, center alignment is performed. Due to the nature of photography, photos taken at different focus point can be shifted or rotated tiny bit from the center of the view point, it is for the best result, the invention performs the center alignment first. FIG. 3 disclosed the center alignment steps, step 305 is to perform translation, step 310 is to perform rotation. FIG. 4 disclosed detailed steps for translation needed for alignment. In step 405, with reference to FIG. 11A, for first input digital image, the width of the image is represented by WIDTH, the height of the image is represented by HEIGHT, the center is positioned at (½WIDTH, ½HEIGHT). In step 415, with reference to FIG. 11A, get next image, try to match the center of the newly got image with previous image. For example, first image we know the center, for second image, we try to match the center with first image. Use 1/20Width area around center as bounding box area, shifting the second image's center area around in horizontal and vertical direction respectively to get the best match with the first image's center. with reference to FIG. 11B, the best match is determined by the sum of mean square deviation, for example, in FIG. 11B, the mean square deviation in first 3×3 area is

$${\sum }_{n = 0}^{n = 2} {( Xn = Yn )}^{2} .$$

The smallest mean square deviation sum will make the best match. The implementation for the translation alignment is to match the current image center area with bounding box of 1/20 of the image WIDTH with the previous image center area, shifting the bounding box from −1/40WIDTH off the origin(0,0) to 1/40WIDTH off origin horizontally and vertically to get the smallest mean square deviation sum. In step 420, once the best center shift is determined for the current image, the current image is shifted for the translation amount. Do the same steps until all the images are processed for translation adjustment.

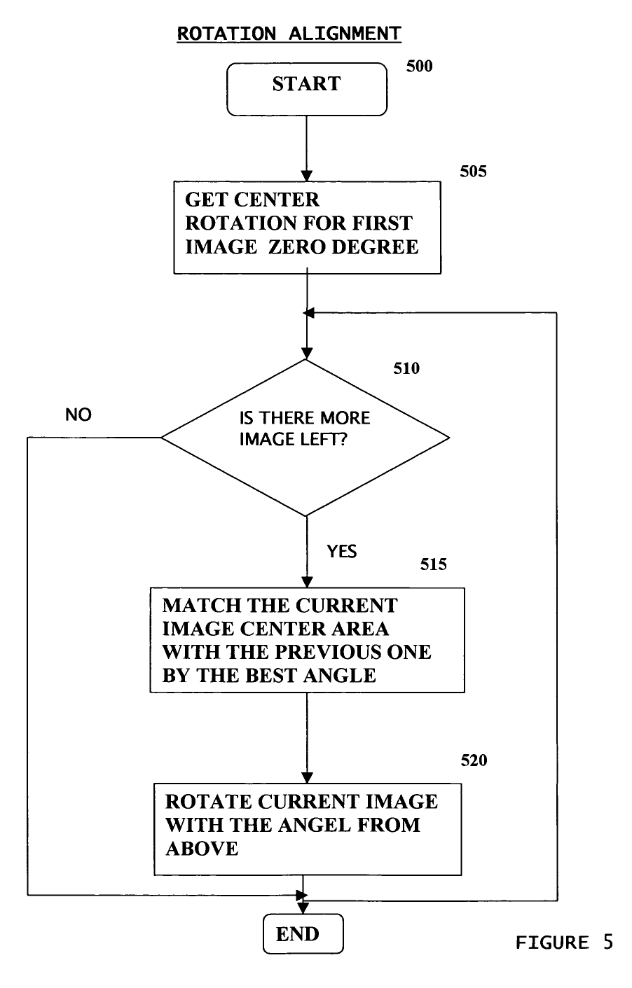

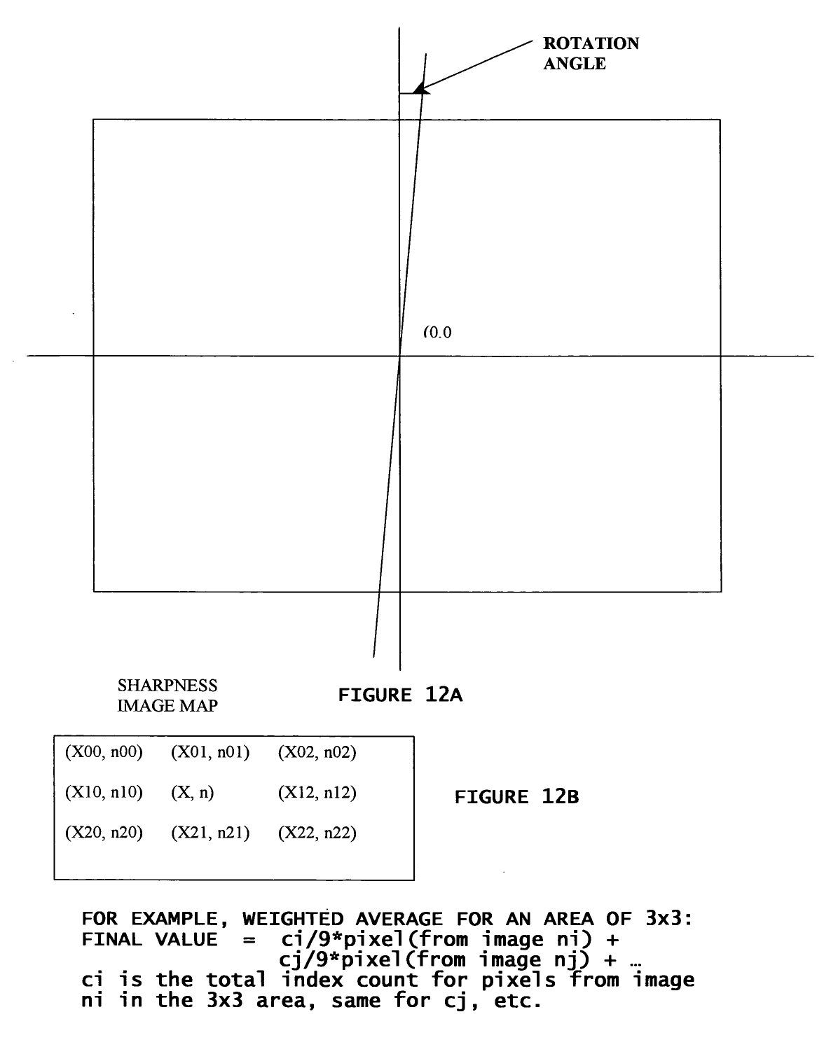

Referring to step 310 in FIG. 3, rotation adjustment for center alignment, FIG. 5 disclosed the detailed steps. In FIG. 5 step 515, with reference to FIG. 12A, determine the best rotation adjustment is done by rotate the current on top of the previous image by a small angel range, from −0.1 degree to +0.1 degree in interval 0.01 to see which angle matches the previous image the best by using the mean square deviation sum as discussed in step 415, in step 520, once the best angle is determined from step 515, then rotate the image. Do the same steps until all the images are processed for rotation adjustment.

In the second step 210 of the embodiment disclosed in FIG. 2, image scale is performed. Due to the focus plane change, image's scale can change a little, such as in close-up photography, or micro-photography. In order to get the best result, the embodiment of the invention perform image scale to make all the images match one another in relative sizes of the point of view. FIG. 6 disclosed detailed steps. with referring to FIG. 6 and FIG. 10A, in step 605, an image area is divided into 8 areas as in FIG. 10A, for each area, find the sharpest point in the area. with reference to FIG. 10B, the sharpest pixel point is determined by the cross neighbor pixels. The largest sum mean square of the adjacent points represent the sharpest point. For example with FIG. 10B, the sharpness value for the center pixel is:

$${\sum }_{i = - 3}^{i = 2} {( Xn + i + 1 - Xn + i )}^{2} + {\sum }_{i = - 3}^{i = 2} {( Yn + i + 1 - Yn + i )}^{2}$$

With referring to FIG. 10A, after finding the sharpest points in each area, calculate the distance between the sharpest points to the center of the image. Using the ratio of the corresponding distances of current image and previous one to determine the scale ratio. Finding the best matching ratio for the eight distance pairs' ratio to be the scale ratio. Do the same steps for all the images to find relative scale ratio. Then scale all the images using their own scale ratio.

In third step 215 of embodiment disclosed in FIG. 2, FIG. 7 gives detailed diagram of the implementation. In FIG. 7, with referring to step 705, the initialization part is to create an image map which will record the sharpest image index at each pixel position, which is basically a matrix same size as of the image, with each element of the matrix is a pair of values, one is a index number range from 0 to maximum number of image minus 1, and the other value is the current largest sharpness value for the images so far. The sharpness value is calculated in the same way as in step 605 with referring to FIG. 10B. Then from step 710 to step 715, it loops through all the pixels from first image to last image to record the largest sharpness values and its corresponding image index.

Now it is the step 220 in FIG. 2, it processes the sharpness image map to smooth out any artifacts from bringing in pixels from different images. FIG. 8 gives detailed diagram for step 220. Step 805 in FIG. 8 scan through all the pixels in sharpness image map generated from step 215 in FIG. 2, find out the largest sharpness value in the sharpness image map, call it max-sharpness-value, use the value as a base to create a histogram indexed as [sharpness-value/max-sharpness-value*N]. create the histogram as scanning through the sharpness image map. Use a percentage as a threshold to get the sharpness value from the histogram, call it threshold-sharpness-value use the threshold-sharpness-value to judge if a given sharpness value is focused or not. In step 810 in FIG. 8, for sharpness values in the sharpness image map which are judged as not focused, search in a small bounding area 20×20 around the not focused point to do a index count for the area. Get the most index count from the area and reset the sharpness value's index, so it will get pixels eventually from the image which most of the pixels are picked from the neighbor area, it will smooth some of the artifacts.

Now turning to step 225 in FIG. 2 to generate the final enhanced DEPTH OF FIELD image. FIG. 9 gives detailed diagram for step 225. In FIG. 9, first step 905 allocates a new memory to store the generated image, then the implementation fill in each pixel for the generated image from step 910 to step 925. In step 915, if the sharpness value is smaller than the threshold-sharpness-value obtained from step 805 in FIG. 8, then get index count from the surrounding area sized as 40×40, with referring to FIG. 12B, use weighted average to get the pixel value of this pixel. In step 920, if the sharpness value is larger or equal to the threshold-sharpness-value, get index count from surrounding area sized as 4×4, with referring to FIG. 12B, use weighted average to get the pixel value for this pixel. Finally in step 925, fill the pixel value into the final generated image which is the enhanced DEPTH OF FIELD image.

FIG. 13 gives an example of the process from three input images, to final image.

In view of the many possible embodiments to which the principles of our invention may be applied, it should be recognized that the embodiment described herein with respect to the drawing figures is only illustrative and should not taken as limiting the scope of the invention. To the contrary, the invention as described herein contemplates all such embodiments as may within the scope of the following claims and equivalents thereof.

1. In a computer system, a method for generating an enhanced DEPTH OF FIELD image from a set of images taken at different point of view, the method comprising the steps of:
1) processing the images to align the center of the images to the same object points in the view, adjust both translation and rotation;
2) processing the images to match the scale of the images, so that all the images have the same scale and match one another exactly;
3) processing the images to determine the sharpest pixel in which image for a pixel position and create a sharpness image map;
4) processing the sharpness image map, use different sized surrounding areas to smooth the pixel so that most of the pixels are from the same image or favor the pixels more frequently from the same image;
5) generating the final image by filling in each pixel which is sharpest among all the images for that pixel position.

2. The method of claim 1, wherein the process 1) and 2) and 3) and 4) and 5) can also be embedded in a hardware device.

3. The method of claim 1, wherein the center alignment, step 1), center alignment can be done manually by the user of the method through a user interface for the method, for example, user can select the center for each image through computer pointing devices such as mouse.

4. The method of claim 1, wherein the digital images to be processed can be input from one of a plurality of possible devices, and the steps in claim 1 are device independent.

5. The method of claim 1, wherein the center alignment, step 1), center alignment can be done at the time images are taken through the photography devices. The photography devices can take a set of shots at different focus points automatically, when user only press shot button once. The set of images will be already center aligned without possibility of user hand shifting during different shots for different focus point.

6. The method of claim 1, wherein processing the pixel's surrounding area for smoothing any artifacts, step 4), may be optional. Pixels generated in step 5) for final enhance DEPTH OF FIELD image can be taken from images with the largest sharpness value indicated and indexed in sharpness image map directly without calculating weighted average.

7. The method of claim 1, further comprising the step of:
smooth any artifacts might have caused by bringing in the pixels from different images. Threshold of the smooth process can be adjusted by user through user interface to be some percent, for example 50%, or 70%, etc. user can adjust the threshold to make the final image look the best.

8. The method of claim 1 further comprising the input images can be far range or medium range or micro range images or any type of images.

9. The method of claim 1 further comprising the input images can contain noise.

10. The method of claim 1 further comprising the number of input images can be two or more images.

11. The method of claim 1 further comprising the order of the input images is not the concern of the method.

12. A computer-readable medium having computer-executable instructions for performing steps, comprising:
1) processing the images to align the center of the images to the same object points in the view, adjust both translation and rotation;
2) processing the above center adjusted images to match the scale of the images, so that all the images have the same scale and match one another exactly;
3) processing the images to determine the sharpest pixel in which image for a pixel position and create a sharpness image map;
4) processing the sharpness image map, use different sized surrounding areas to smooth the pixel so that most of the pixels are from the same image or favor the pixels more frequently from the same image;
5) generating the final image by filling in each pixel which is sharpest among all the images for that pixel position.

13. A computer-readable medium of claim 10, wherein the center alignment, center alignment can be done at the time images are taken through the photography devices. The photography devices can take a set of shots at different focus points automatically, when user only press shot button once. The set of images will be already center aligned without possibility of user hand shifting during different shots for different focus point.

14. A computer-readable medium of claim 10, wherein processing the pixel's surrounding area for smoothing any artifacts, step 4), may be optional. Pixels generated in step 5) for final enhance DEPTH OF FIELD image can be taken from images with the largest sharpness value indicated and indexed in sharpness image map directly without calculating weighted average.

15. A computer-readable medium of claim 10 further comprising the input images can be far range or medium range or micro range images or any type of images.

16. A computer-readable medium of claim 10 further comprising the input images can contain noise.

17. A computer-readable medium of claim 10 further comprising the number of input images can be two or more images.

18. A computer-readable medium of claim 10 further comprising the order of the input images is not the concern of the method.
